(19) United States
(12) Patent Application Publication
(10) Pub. No.: US 2025/0267506 A1
(43) Pub. Date: Aug. 21, 2025

(54) COMMUNICATION DEVICE

(71) Applicant: Toyota Jidosha Kabushiki Kaisha, Toyota-shi (JP)

(72) Inventor: Shinnosuke SUGAWARA, Toyota-shi (JP)

(73) Assignee: Toyota Jidosha Kabushiki Kaisha, Toyota-shi (JP)

(21) Appl. No.: 18/965,328

(22) Filed: Dec. 2, 2024

(30) Foreign Application Priority Data
Feb. 21, 2024 (JP) 2024-024494

(51) Int. Cl. H04W 28/04; H04W 12/06; H04W 12/106

(52) U.S. Cl. CPC H04W 28/04; H04W 12/06; H04W 12/106

(57) ABSTRACT

The communication device that manages the first element of the freshness value transmits information indicating the first element to another communication device. The other communication device stores the received first element. A transmitting device, which is a communication device that transmits a message, transmits a message including a freshness value incorporating a stored first element. A receiving apparatus, which is a communication device that receives a message, attempts to authenticate the message by comparing a freshness value included in the received message with the freshness value that incorporates the first element stored therein. When the authentication fails, the reception device stores error information indicating that the authentication fails. The transmission device stores information indicating that the first element is lost after the first element is lost and before receiving the information indicating the first element.

### CROSS-REFERENCE TO RELATED APPLICATION

This application claims priority to Japanese Patent Application No. 2024-024494 filed on Feb. 21, 2024, incorporated herein by reference in its entirety.

### BACKGROUND

### 1. Technical Field

The present disclosure relates to a communication device.

### 2. Description of Related Art

Japanese Unexamined Patent Application Publication No. 2017-38365 (JP 2017-38365 A) describes a communication network system constituted by a plurality of communication devices. The communication devices transmit a message that includes a freshness value composed of a first element and a second element to another communication device. The communication network system includes a transmission device, a reception device, and a management device as the communication devices.

In the communication network system, the management device manages the first element of the freshness value. The management device transmits a value as the first element of the freshness value to the transmission device and the reception device.

In the communication network system, the transmission device transmits a message that includes a freshness value. At this time, the first element of the freshness value is a value received from the management device. Meanwhile, the second element of the freshness value is a value set by the transmission device itself.

In the communication network system, the reception device receives a message from the transmission device. The reception device verifies the received message based on the freshness value included in the message. The reception device accepts the received message when the message is successfully authenticated as a result of verifying the message.

### SUMMARY

The transmission device temporarily stores a value as the first element of the freshness value, received from the management device. In the communication network system, the freshness value stored in the transmission device may be lost if power supply for the transmission device is instantaneously interrupted, for example. Therefore, the transmission device may set a freshness value with an incomplete first element when attempting to transmit a message after losing the stored value and before receiving a first element of a freshness value from the management device. In this case, the reception device may fail in authenticating the message.

When the authentication of the message has failed, the reception device records error information indicating that the authentication has failed in a storage device. It is possible to know that the authentication has failed by checking the error information recorded in the reception device. However, it cannot be determined from the error information alone whether the failure in the authentication is due to the loss of the freshness value stored in the transmission device or due to an event other than such a loss, such as a cyber attack.

In order to address the above issue, an aspect provides a communication device, that is,
a transmission-side communication device that transmits a message in a communication network system.
   The communication network system is constituted by a plurality of communication devices. In the communication network system,
a message that includes a freshness value composed of a first element and a second element is transmitted and received between the communication devices.
   The communication network system is configured such that a communication device that manages the first element, among the communication devices, transmits information that indicates the first element to another communication device.
   The communication network system is configured such that a communication device that has received the information that indicates the first element stores the first element indicated by the information.
   The communication network system is configured such that the transmission-side communication device transmits the message that includes the freshness value that incorporates the first element stored in the transmission-side communication device itself.
   The communication network system is configured such that a reception-side communication device that receives the message attempts authentication of the received message by comparing the freshness value included in the received message and the freshness value that incorporates the first element stored in the reception-side communication device itself, and stores information indicating that the authentication has failed when the authentication has failed as a result of attempting the authentication.
   The transmission-side communication device includes a processing device.
   The processing device in the transmission-side communication device stores information indicating that the first element has been lost after losing the stored first element and before receiving information that indicates the first element.

In order to address the above issue, an aspect provides a communication device, that is,
a reception-side communication device that receives a message in a communication network system.
   The communication network system is constituted by a plurality of communication devices. In the communication network system, a message that includes a freshness value composed of a first element and a second element is transmitted and received between the communication devices.
   The communication network system is configured such that a communication device that manages the first element, among the communication devices, transmits information that indicates the first element to another communication device.
   The communication network system is configured such that a communication device that has received the information that indicates the first element stores the first element indicated by the information.
   The communication network system is configured such that a transmission-side communication device that transmits the message transmits the message that includes the freshness value that incorporates the first element stored in the transmission-side communication device itself.
   The communication network system is configured such that the reception-side communication device attempts authentication of the received message by comparing the freshness value included in the received message and the freshness value that incorporates the first element stored in the reception-side communication device itself, and stores information indicating that the authentication has failed when the authentication has failed as a result of attempting the authentication.
   The reception-side communication device includes a processing device.
   The processing device in the reception-side communication device stores information indicating that the first element has been lost in the transmission-side communication device when receiving a notification from the transmission-side communication device, the notification indicating that the first element stored in the transmission-side communication device has been lost.

In order to address the above issue, an aspect provides a communication device, that is,
a communication device that is neither a transmission-side communication device nor a reception-side communication device, among a plurality of communication devices in a communication network system.
   The communication network system is constituted by a plurality of communication devices. In the communication network system, a message that includes a freshness value composed of a first element and a second element is transmitted and received between the communication devices.
   The communication network system is configured such that a communication device that manages the first element, among the communication devices, transmits information that indicates the first element to another communication device.
   The communication network system is configured such that a communication device that has received the information that indicates the first element stores the first element indicated by the information.
   The communication network system is configured such that a transmission-side communication device that transmits the message transmits the message that includes the freshness value that incorporates the first element stored in the transmission-side communication device itself.
   The communication network system is configured such that a reception-side communication device that receives the message attempts authentication of the received message by comparing the freshness value included in the received message and the freshness value that incorporates the first element stored in the reception-side communication device itself, and stores information indicating that the authentication has failed when the authentication has failed as a result of attempting the authentication.
   The communication device that is neither the transmission-side communication device nor the reception-side communication device, among the communication devices, includes a processing device.
   The processing device stores information indicating that the first element has been lost in the transmission-side communication device when receiving a notification from the transmission-side communication device, the notification indicating that the first element stored in the transmission-side communication device has been lost.

According to the communication device described above, it is possible to determine whether error information is caused by the loss of the first element by checking information indicating that the first element stored in the communication device has been lost when the error information is recorded in the reception-side communication device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a communication network system including a communication device according to a first embodiment;

FIG. 2 is a sequence diagram illustrating aspects of communication by a message including a freshness value;

FIG. 3 is a sequence diagram illustrating a mode of communication executed when a first element stored in a transmission device disappears in the communication network system including the communication device according to the first embodiment;

FIG. 4 is a sequence diagram illustrating a mode of communication executed when a first element stored in a transmission device disappears in the communication network system including the communication device according to the second embodiment;

FIG. 5 is a schematic diagram illustrating a configuration of a communication network system including a communication device according to a third embodiment; and

FIG. 6 is a sequence diagram illustrating an aspect of communication performed in a case where a first element stored in a transmission device disappears in the communication network system including the communication device according to the third embodiment.

### DETAILED DESCRIPTION OF EMBODIMENTS

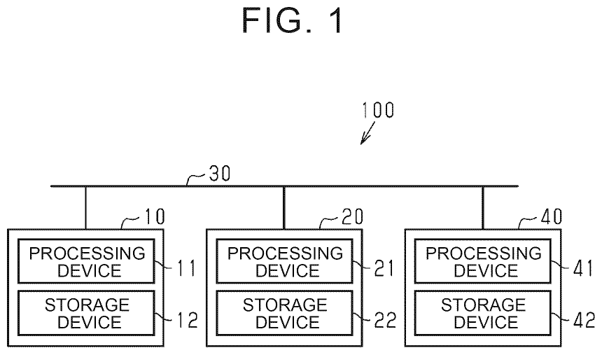

Hereinafter, a communication device according to a first embodiment will be described with reference to FIG. 1 to FIG. 3.

### Configuration of Communication Network System 100

As illustrated in FIG. 1, the communication network system 100 includes a plurality of communication devices. Specifically, the communication network system 100 includes, as communication devices, a transmission device 10, a reception device 20, and a management device 40. The communication network system 100 is applied to, for example, a vehicle. The transmission device 10, the reception device 20, and the management device 40 in the communication network system 100 are, for example, electronic control devices provided in a vehicle.

As illustrated in FIG. 1, the transmission device 10, the reception device 20, and the management device 40 are communicably connected via a communication bus 30. In the communication network system 100, messages including freshness values are transmitted and received between a plurality of communication devices.

The transmission device 10 is a communication device on a transmission side that transmits a message among a plurality of communication devices in the communication network system 100. As illustrated in FIG. 1, the transmission device 10 includes a processing device 11 and a storage device 12. A program is stored in the storage device 12. The processing device 11 executes programs stored in the storage device 12 to execute various processes. The processing device 11 includes a processor.

The reception device 20 is a communication device on a reception side that receives a message among a plurality of communication devices in the communication network system 100. As illustrated in FIG. 1, the reception device 20 includes a processing device 21 and a storage device 22. A program is stored in the storage device 22. The processing device 21 executes programs stored in the storage device 22 to execute various processes. The processing device 21 includes a processor.

The transmission device 10 transmits a message including the freshness value to the reception device 20. The freshness value is composed of a first element and a second element.

The first element of the freshness value is the upper digit of the freshness value. The first element, which is a high-order digit of the freshness value, includes a trip counter and a reset counter.

On the other hand, the second element of the freshness value is the lower digit of the freshness value. The second element, which is the lower digit of the freshness value, is constituted by a message counter. The transmission device 10 manages the value of the message counter.

The higher the upper digit, the higher the freshness value. When the upper digits are the same, the higher the lower digit, the higher the freshness value.

The management device 40 is a communication device that manages the first element of the freshness value among the plurality of communication devices in the communication network system 100. That is, the management device 40 manages the values of the trip counter and the reset counter, which are the high-order digits of the freshness value.

As illustrated in FIG. 1, the management device 40 includes a processing device 41 and a storage device 42. A program is stored in the storage device 42. The processing device 41 executes programs stored in the storage device 42 to execute various kinds of processing. The processing device 41 includes a processor.

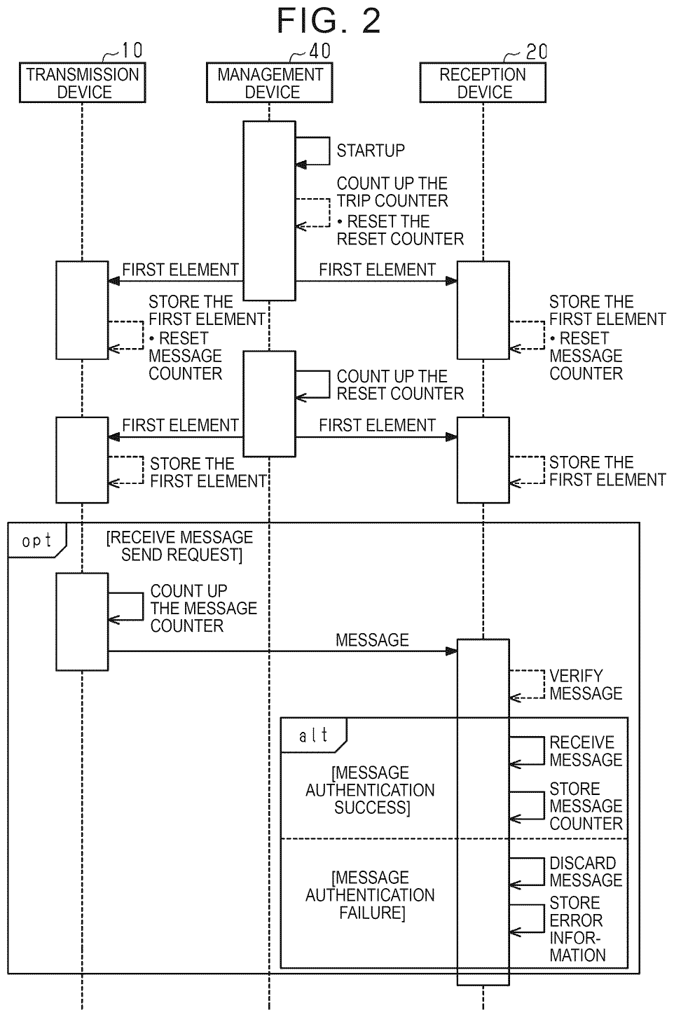

With reference to FIG. 2, an aspect in which the management device 40 manages the first element and an aspect in which the transmission device 10 manages the second element will be described.

Mode in which the management device 40 manages the first element of the freshness value FIG. 2 illustrates an example of aspects of communications performed in a communication network system 100. The processing executed by the transmission device 10 in FIG. 2 is executed by the processing device 11. In FIG. 2, the processing performed by the reception device 20 is performed by the processing device 21. In FIG. 2, processing executed by the management device 40 is executed by the processing device 41.

As illustrated in the upper part of FIG. 2, the management device 40 counts up the trip counter after starting up. The management device 40 stores the trip counter in the storage device 42 when the operation is stopped. Then, the management device 40 reads the trip counter from the storage device 42 at the time of activation, and then counts up the read trip counter.

As illustrated in the upper part of FIG. 2, the management device 40 resets the reset counter at the same time as counting up the trip counter. That is, the management device 40 sets the reset counter to the minimum value at the time of activation.

As illustrated in the upper part of FIG. 2, the management device 40 transmits information indicating the first element of the freshness value to the transmission device 10 and the reception device 20. At this time, the management device 40 transmits information indicating the trip counter counted up at the time of activation and the reset counter that has been reset.

As illustrated in the upper part of FIG. 2, the transmission device 10 that has received the information of the first element from the management device 40 stores the received first element in the storage device 12. In addition, the transmission device 10 resets the message counter when receiving the information indicating the reset counter. Thus, the message counter is reset every time the reset counter is reset, and becomes a minimum value.

As illustrated in the upper part of FIG. 2, the reception device 20 that has received the information of the first element from the management device 40 stores the received first element in the storage device 22. When receiving the information indicating the reset counter, the reception device 20 resets the message counter stored therein. As will be described later, when receiving a message received from the transmission device 10, the reception device 20 stores a message counter of a freshness value included in the message in the storage device 22. When receiving the information indicating the reset counter reset from the management device 40, the reception device 20 discards the stored message counter and then stores the message counter having the minimum value.

As illustrated in the middle part of FIG. 2, the management device 40 counts up the reset counter every time a certain period of time elapses while it is activated. Then, the management device 40 transmits the information of the first element including the counted-up reset counter to the transmission device 10 and the reception device 20.

As illustrated in the middle part of FIG. 2, the transmission device 10 that has received the information of the first element from the management device 40 stores the received first element in the storage device 12. On the other hand, the reception device 20 that has received the information of the first element from the management device 40 stores the received first element in the storage device 22.

Thereafter, the management device 40 counts up the reset counter every time a certain period of time elapses. Then, the management device 40 transmits information of the first element including the counted-up reset counter to another communication device.

In this way, the management device 40 transmits information indicating the first element to another communication device. On the other hand, the communication device that has received the information indicating the first element from the management device 40 stores the first element indicated by the information.

### Manner in Which Transmission Device 10 Manages Second Element of Freshness Value

As illustrated in the lower part of FIG. 2, when receiving a message transmission request, the transmission device 10 counts up the message counter. The message counter is counted up each time the transmission device 10 transmits a message. The transmission device 10 counts up the message counter when, for example, a message requesting transmission of a message is received from the reception device 20.

As illustrated in the lower part of FIG. 2, the transmission device 10 that counts up the message counter transmits a message including the freshness value. At this time, the first element, which is the upper digit of the freshness value included in the message transmitted by the transmission device 10, is the value received from the management device 40 in the upper stage and the middle stage of FIG. 2. At this time, the second element, which is the lower digit of the freshness value included in the message transmitted by the transmission device 10, is a value counted up by itself in the lower stage of FIG. 2. In this way, the transmission device 10 transmits a message including a freshness value incorporating the first element stored therein.

If the transmission device 10 receives a message transmission request before receiving the counted-up reset counter, it may transmit the message before receiving the counted-up reset counter.

As illustrated in the lower part of FIG. 2, the reception device 20 that has received the message verifies the received message. The reception device 20 verifies the integrity of the received message by verifying the message. That is, the reception device 20 confirms whether the message is correctly transmitted from the transmission device 10, whether the message is affected by a cyber attack or the like, and the like through the verification of the message.

When the reception device 20 confirms the integrity of the received message through the verification of the message, the authentication of the message is successful. On the other hand, when the integrity of the received message cannot be confirmed through the verification of the message, the reception device 20 fails to authenticate the message.

In the verification of the message, the reception device 20 compares the freshness value included in the received message with the freshness value for verification. The first element, which is a high-order digit of the freshness value for verification, is a value received from the management device 40 and stored in the upper and middle stages of FIG. 2.

When the received message is successfully authenticated, the reception device 20 stores the message counter of the freshness value included in the message in the storage device 22. The second element, which is the lower digit of the freshness value for verification, is the value of the message counter included in the message received from the transmission device 10, which is stored in the storage device 22 after the message received by the reception device 20 is successfully authenticated.

The transmission device 10 counts up the message counter before transmitting the message. Therefore, when the reception device 20 normally receives the message, the freshness value included in the received message is larger than the freshness value for verification. When the freshness value included in the received message is larger than the freshness value for verification, the reception device 20 succeeds in authenticating the message. As illustrated in the lower part of FIG. 2, when the received message is successfully authenticated, the reception device 20 receives the message. Thereafter, the message counter included in the received message is stored in the storage device 22.

When the freshness value included in the received message is equal to or less than the freshness value for verification, the reception device 20 fails to authenticate the message. As illustrated in the lower part of FIG. 2, when authentication of the received message fails, the reception device 20 discards the message without accepting the message.

As illustrated in the lower part of FIG. 2, after discarding the message, the reception device 20 stores the error information in the storage device 22. The error information is information indicating that the reception device 20 has failed to authenticate the message. By checking the error information recorded in the reception device 20, it is possible to know that the reception device 20 has failed to authenticate the message.

As described above, the reception device 20 compares the freshness value included in the received message with the freshness value including the first element stored therein, and attempts to authenticate the received message. Then, the reception device 20 stores information indicating that the authentication has failed when the authentication has failed as a result of attempting the authentication.

### Communication Mode When First Element Stored in Transmission Device 10 is Lost

As described with reference to FIG. 2, the transmission device 10 stores the first element of the freshness value received from the management device 40 in the storage device 12. Then, the transmission device 10 transmits a message including the stored freshness value incorporating the first element to the reception device 20.

The transmission device 10 stores the first element of the freshness value received from the management device 40 in the volatile memory of the storage device 12. That is, the transmission device 10 only temporarily stores the first element received from the management device 40. Therefore, in the communication network system 100, when the power source is interrupted or the like in the transmission device 10, there is a possibility that the first element stored in the transmission device 10 is lost.

As described with reference to FIG. 2, the management device 40 transmits information indicating the first element of the freshness value every time a certain period of time elapses. If the transmission device 10 transmits a message before receiving the information indicating the first element from the management device 40 after the stored first element disappears, the first element of the freshness value will transmit the message in an incomplete state.

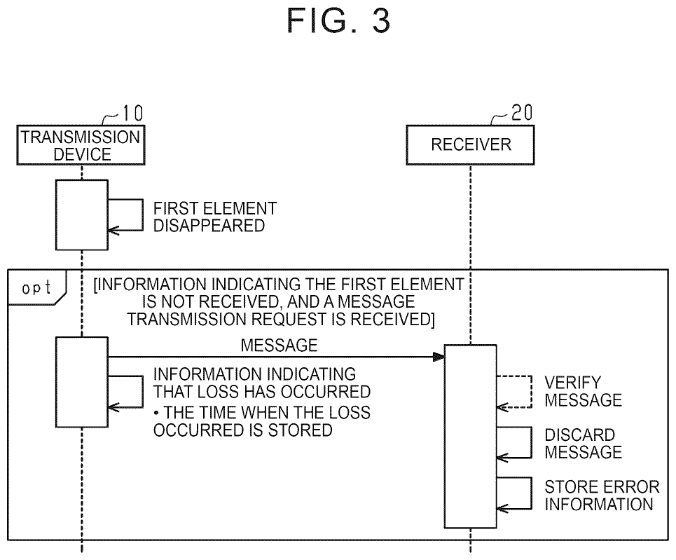

FIG. 3 illustrates an aspect of communication in which the transmission device 10 transmits a message before receiving information indicating the first element from the management device 40 after the first element of the stored freshness value disappears. In FIG. 3, processing executed by the transmission device 10 is executed by the processing device 11. In FIG. 3, the processing performed by the reception device 20 is performed by the processing device 21.

In FIG. 3, the transmission device 10 receives a message transmission request after the stored first element disappears and before receiving information indicating the first element from the management device 40. In FIG. 3, the transmission device 10 that has received the message transmission request transmits a message to the reception device 20. At this time, the transmission device 10 transmits a message including the freshness value of the minimum value.

As illustrated in FIG. 3, after transmitting the message, the transmission device 10 stores information indicating that the stored first element has been lost in the storage device 12. As described above, the processing device 11 of the transmission device 10 performs the storing of the information indicating that the erasure has occurred after the stored first element has disappeared and before receiving the information indicating the first element.

As illustrated in FIG. 3, when the transmission device 10 stores information indicating that the first element has been lost, the time when the first element has been lost is also stored in the storage device 12. As described above, the processing device 11 of the transmission device 10 executes storing the time at which the disappearance has occurred in addition to the information indicating that the disappearance has occurred.

As illustrated in FIG. 3, the reception device 20 that has received the message from the transmission device 10 verifies the message in the same manner as in the lower part of FIG. 2. In FIG. 3, since the freshness value included in the message received by the reception device 20 is the minimum value, the reception device 20 fails to authenticate the message in the verification of the message. Therefore, as illustrated in FIG. 3, the reception device 20 discards the received message after the verification of the message. The reception device 20 that has discarded the message stores the error information in the storage device 22.

Only by confirming the reception device 20 can the reception device 20 know that the authentication of the message has failed. However, by checking the transmission device 10, it can be determined that the authentication failure is caused by the loss of the first element stored in the transmission device 10. Further, since the transmission device 10 stores the time at which the loss occurred, it is also possible to know the time at which the loss occurred by checking the transmission device 10.

### Operation of First Embodiment

The transmission device 10, which is the communication device on the transmission side, stores information indicating that the first element of the freshness value stored therein has disappeared.

### Effect of First Embodiment

(1) When error information is recorded in the reception device 20, which is the communication device on the receiving side, it is possible to determine whether or not the error information is caused by disappearance by checking the information stored in the transmission device 10.

(2) The processing device 11 of the transmission device 10 executes storing the time at which the loss has occurred, in addition to the information indicating that the loss has occurred. This makes it possible to know the time at which the disappearance has occurred by checking the time stored in the storage device 12 of the transmission device 10.

### Second Embodiment

Hereinafter, a communication device according to a second embodiment will be described with reference to the drawings. A common configuration in the communication network system 100 including the communication devices according to the first and second embodiments will be omitted. The aspects of the communication of the message including the freshness value executed in the communication network system 100 are the same as the aspects described with reference to FIG. 2.

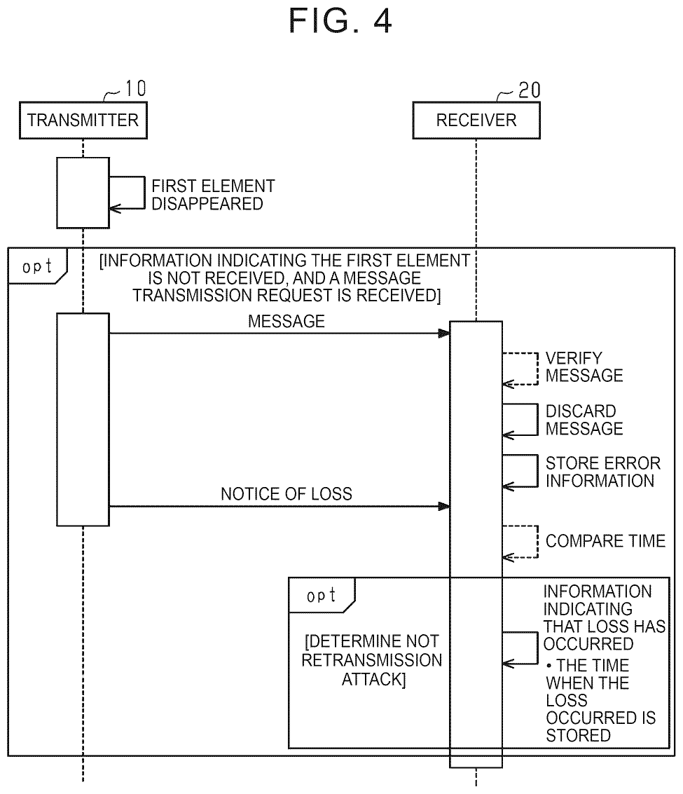

FIG. 4 illustrates an aspect of communication in which the transmission device 10 transmits a message before receiving information indicating the first element from the management device 40 after the first element of the stored freshness value disappears. In FIG. 4, the processing performed by the transmission device 10 is performed by the processing device 11. In FIG. 4, the processing performed by the reception device 20 is performed by the processing device 21.

In FIG. 4, the transmission device 10 receives a message transmission request after the stored first element disappears and before receiving information indicating the first element from the management device 40. In FIG. 4, the transmission device 10 that has received the message transmission request transmits a message to the reception device 20. At this time, the transmission device 10 transmits a message including the freshness value of the minimum value.

As illustrated in FIG. 4, the reception device 20 that has received the message from the transmission device 10 verifies the message. In FIG. 4, since the freshness value included in the message received by the reception device 20 is the minimum value, the reception device 20 fails to authenticate the message in the verification of the message. As illustrated in FIG. 4, the reception device 20 discards the received message after the verification of the message. Then, the reception device 20 that has discarded the message stores the error information in the storage device 22.

As illustrated in FIG. 4, after transmitting the message, the transmission device 10 transmits a loss notification to the reception device 20. The disappearance notification is a notification indicating that the first element stored in the transmission device 10 has disappeared and a time at which the disappearance has occurred. The reception device 20 receives the loss notification as a notification indicating that the loss of the first element stored in the transmission device 10 has occurred.

One cyber attack on the communication network system 100 is a retransmission attack that attempts to break through verification by intercepting and retransmitting a message transmitted by the transmission device 10. As will be described later, the reception device 20 stores information indicating that the first element stored in the transmission device 10 has been lost, based on the received loss notification. The reception device 20 may store information indicating that the loss has occurred even if the loss has not occurred due to the retransmission attack.

As illustrated in FIG. 4, the reception device 20 determines whether the received loss notification is a retransmission attack by comparing the time at which the loss indicated by the last received loss notification occurred with the time at which the loss indicated by the last received loss notification occurred. Specifically, the reception device 20 determines that the extinction notification received this time is not due to a retransmission attack when the time at which the extinction indicated by the extinction notification received this time occurred indicates a time after the time at which the extinction indicated by the extinction notification received last time occurred.

As illustrated in FIG. 4, when determining that the received loss notification is not due to a retransmission attack, the reception device 20 stores information indicating that the loss of the first element stored in the transmission device 10 has occurred in the storage device 22. As such, the processing device 21 of the reception device 20 executes to store information indicating that disappearance has occurred in the transmission device 10 when receiving a notification indicating that disappearance of the first element stored in the transmission device 10 has occurred from the transmission device 10.

As illustrated in FIG. 4, when the reception device 20 stores information indicating that the first element stored in the transmission device 10 has been lost, the time at which the first element has been lost is also stored in the storage device 22. As described above, the processing device 21 of the reception device 20 executes storing the time at which the loss has occurred, in addition to the information indicating that the loss has occurred. When the processing device 21 receives the loss notification, the time indicated by the received notification may indicate a time later than the time indicated by the notification received before the notification. In such a case, the processing device 21 executes storing information indicating that the disappearance has occurred and a time at which the disappearance has occurred.

According to the second embodiment, by confirming the reception device 20, it can be determined that the authentication failure is caused by the loss of the first element stored in the transmission device 10. Further, since the reception device 20 stores the time at which the loss has occurred, it is also possible to know the time at which the loss has occurred by checking the reception device 20.

In a case where the information indicating that the erasure has occurred is stored, the reception device 20 may discard the error information corresponding to the erasure stored in the storage device 22. For example, when receiving the loss notification within a certain period of time centered on the time point at which the error information is stored, the reception device 20 recognizes that the loss notification corresponds to the error information stored by itself. Then, the reception device 20 discards the error information stored therein when the information indicating that the loss has occurred is stored based on the received loss notification.

In addition, the reception device 20 may adopt a configuration in which the error information is not stored in the first place when the information indicating that the message has been lost is stored within a certain period of time centered on the time point at which the message is discarded.

In addition, the reception device 20 may adopt a configuration in which the error information is not stored in the first place when the loss notification is received within a certain period of time centered on the time point at which the message is discarded. In this case, after receiving the loss notification, the reception device 20 determines whether the loss notification is caused by a retransmission attack based on the time indicated by the loss notification. The reception device 20 that has determined that the loss notification is not caused by the retransmission attack stores information indicating that the loss has occurred and a time at which the loss has occurred, without storing the error information.

### Operation of Second Embodiment

The reception device 20, which is the communication device on the reception side, records information indicating that the first element of the freshness value stored in the transmission device 10, which is the communication device on the transmission side, has disappeared.

### Effect of Second Embodiment

(1) When error information is recorded in the reception device 20, it is possible to determine whether or not the error information is caused by disappearance by checking the information stored in the reception device 20.

(2) The processing device 21 of the reception device 20 executes storing the time at which the disappearance has occurred in addition to the information indicating that the disappearance has occurred. This makes it possible to know the time at which the disappearance has occurred by checking the time stored in the storage device 22 of the reception device 20.

(3) The processing device 21 receives, from the transmission device 10, a notification indicating that the first element stored in the transmission device 10 has disappeared and a notification indicating a time at which the disappearance has occurred, as a notification indicating that the disappearance has occurred. When the processing device 21 receives the notification, the time indicated by the received notification may indicate a time later than the time indicated by the notification received before the notification. In such a case, the processing device 21 executes storing information indicating that the disappearance has occurred and a time at which the disappearance has occurred.

One cyber attack on the communication network system 100 is a retransmission attack that attempts to break through verification by intercepting and retransmitting a message transmitted by the transmission device 10.

In a case where the configuration of the second embodiment is not adopted, if a retransmission attack is received, there is a possibility that the communication device that records the loss stores information indicating that the loss has occurred even if the loss has not occurred. In the configuration of the second embodiment, the reception device 20 compares the time at which the loss indicated by the notification received in the past occurred with the time at which the loss indicated by the notification received this time occurred. Then, when the time at which the loss indicated by the notification received this time occurred indicates a time later than the time indicated by the notification received in the past, the reception device 20 stores information indicating that the loss occurred and the time at which the loss occurred. This makes it possible for the reception device 20 to suppress erroneous information being stored in response to a retransmission attack.

### Third Embodiment

Hereinafter, a communication device according to a third embodiment will be described with reference to the drawings. A common configuration in the communication network system 100 including the communication devices according to the first, second, and third embodiments will be omitted. The aspects of the communication of the message including the freshness value executed in the communication network system 100 are the same as the aspects described with reference to FIG. 2.

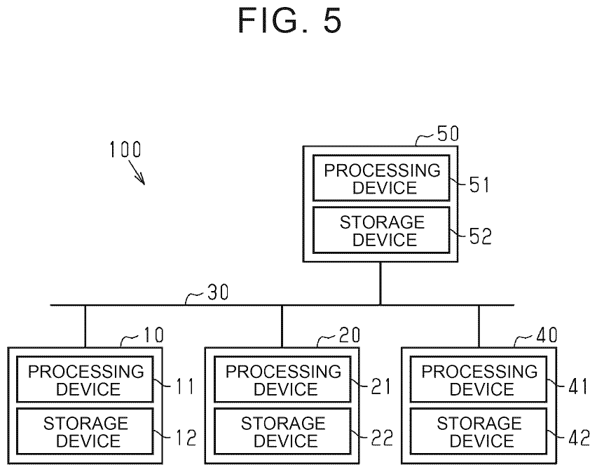

FIG. 5 shows a configuration of a communication network system 100 including the communication device according to the third embodiment. As illustrated in FIG. 5, in the communication network system 100 including the communication device of the third embodiment, the detection device 50 is added to the communication network system 100 illustrated in FIG. 1.

The detection device 50 is a communication device that detects that the first element stored in the transmission device 10 has been lost in the communication network system 100. In the communication network system 100, the detection device 50 is a communication device that is not the transmission device 10 that is the communication device on the transmission side or the reception device 20 that is the communication device on the reception side, among the plurality of communication devices.

As illustrated in FIG. 5, the detection device 50 includes a processing device 51 and a storage device 52. A program is stored in the storage device 52. The processing device 51 executes programs stored in the storage device 52 to execute various kinds of processing. The processing device 51 includes a processor.

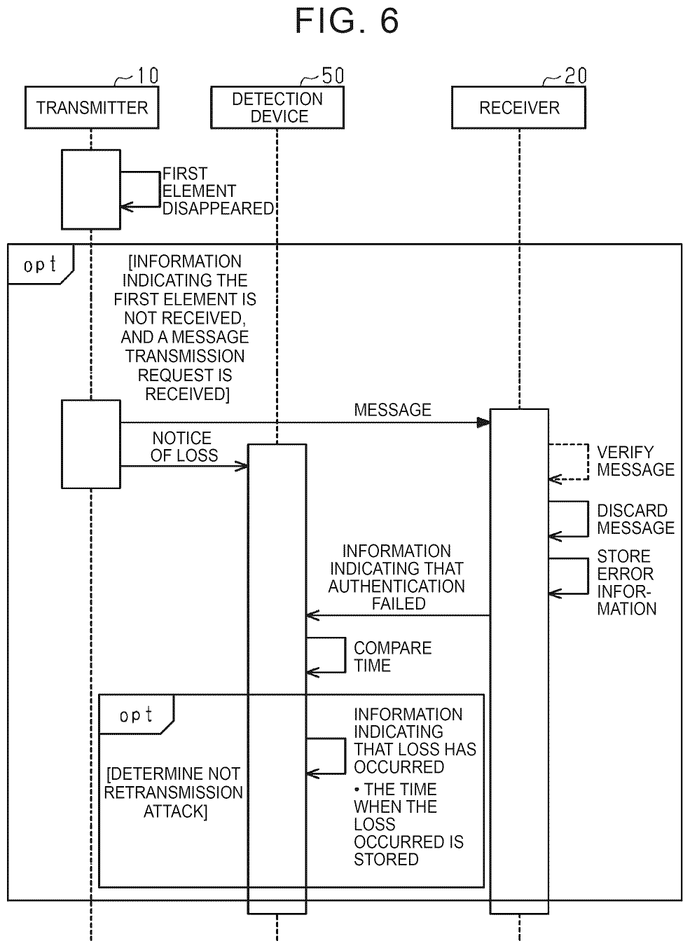

FIG. 6 illustrates an aspect of communication in which the transmission device 10 transmits a message before receiving information indicating the first element from the management device 40 after the first element of the stored freshness value disappears. In FIG. 6, processing executed by the transmission device 10 is executed by the processing device 11. In FIG. 6, the processing performed by the reception device 20 is performed by the processing device 21. In FIG. 6, processing executed by the detection device 50 is executed by the processing device 51.

In FIG. 6, the transmission device 10 receives a message transmission request after the stored first element disappears and before receiving information indicating the first element from the management device 40. In FIG. 6, the transmission device 10 that has received the message transmission request transmits a message to the reception device 20. At this time, the transmission device 10 transmits a message including the freshness value of the minimum value.

As illustrated in FIG. 6, after transmitting the message, the transmission device 10 transmits a loss notification to the detection device 50. The detection device 50 receives the loss notification as a notification indicating that the loss of the first element stored in the transmission device 10 has occurred.

As illustrated in FIG. 6, the reception device 20 that has received the message from the transmission device 10 verifies the message. In FIG. 6, since the freshness value included in the message received by the reception device 20 is the minimum value, the reception device 20 fails to authenticate the message in the verification of the message. As illustrated in FIG. 6, the reception device 20 discards the received message after the verification of the message.

As illustrated in FIG. 6, the reception device 20 that has discarded the message stores the error information in the storage device 22. Thereafter, the reception device 20 transmits information indicating that the authentication of the message has failed to the detection device 50.

As illustrated in FIG. 6, the detection device 50 that has received the loss notification and the information indicating that the authentication of the message has failed compares the time at which the loss indicated by the loss notification received last time occurred with the time at which the loss indicated by the loss notification received this time occurred. After receiving the loss notification, the detection device 50 may start the comparison of the time without waiting for the reception of the information indicating that the authentication of the message has failed.

The mode in which the detection device 50 compares the times is the same as the mode in which the reception device 20 compares the times in FIG. 4. Thus, the detection device 50 can determine whether the received loss notification is due to a retransmission attack.

As illustrated in FIG. 6, when the detection device 50 determines that the received loss notification is not due to a retransmission attack as a result of the time comparison, it stores information indicating that the loss of the first element stored in the transmission device 10 has occurred in the storage device 52. Thus, the processing device 51 of the detection device 50 executes, when receiving a notification from the transmission device 10 indicating that the disappearance of the first element stored in the transmission device 10 has occurred, storing information indicating that the disappearance has occurred in the transmission device 10.

As illustrated in FIG. 6, the detection device 50 also stores, in the storage device 52, the time at which the loss of the first element has occurred, when storing information indicating that the loss of the first element stored in the transmission device 10 has occurred. As described above, the processing device 51 of the detection device 50 executes storing the time at which the disappearance has occurred in addition to the information indicating that the disappearance has occurred. When the processing device 51 receives the loss notification, the time indicated by the received notification may indicate a time later than the time indicated by the notification received before the notification. In such a case, the processing device 51 executes storing information indicating that the disappearance has occurred and a time at which the disappearance has occurred.

According to the third embodiment, by confirming the detection device 50, it can be determined that the failure of the authentication of the message by the reception device 20 is due to the disappearance of the first element stored in the transmission device 10. Further, since the detection device 50 stores the time at which the disappearance has occurred, it is also possible to know the time at which the disappearance has occurred by checking the detection device 50.

The detection device 50, while receiving information indicating that the recognition failed from the reception device 20, when the information indicating that the loss has occurred itself does not store, it is also possible to determine that the failure of the recognition by the reception device 20 is due to a cyber attack or the like. In this case, the detection device 50 stores information indicating that the communication device in the communication network system 100 is likely to be subjected to a cyber attack in the storage device 22. In addition, the detection device 50 may notify the user or the like that there is a possibility that the communication device in the communication network system 100 is undergoing a cyber attack.

### Operation of Third Embodiment

In the message exchange, the detection device 50, which is a communication device from the standpoint of a third party, records information indicating that the first element of the freshness value stored in the transmission device 10, which is a communication device on the transmission side, has disappeared.

### Effect of Third Embodiment

(1) Even when error information is recorded in the reception device 20, which is the communication device on the receiving side, it is possible to determine whether or not the error information is caused by loss by checking the information stored in the detection device 50.

(2) The processing device 51 of the detection device 50 executes storing the time at which the disappearance has occurred, in addition to the information indicating that the disappearance has occurred. This makes it possible to know the time at which the disappearance has occurred by checking the time stored in the storage device 52 of the detection device 50.

(3) The processing device 51 receives, from the transmission device 10, a notification indicating that the first element stored in the transmission device 10 has disappeared and a notification indicating a time at which the disappearance has occurred, as a notification indicating that the disappearance has occurred. When the processing device 51 receives the notification, the time indicated by the received notification may indicate a time later than the time indicated by the notification received before the notification. In such a case, the processing device 51 executes storing information indicating that the disappearance has occurred and a time at which the disappearance has occurred.

In the above-described configuration, the detection device 50 compares the time at which the loss indicated by the notification received in the past has occurred with the time at which the loss indicated by the notification received this time has occurred. Then, the detection device 50 stores information indicating that the loss has occurred and a time at which the loss has occurred, when the time at which the loss indicated by the notification received this time has occurred indicates a time later than the time indicated by the notification received in the past. Accordingly, the detection device 50 can suppress erroneous information being stored in response to a retransmission attack.

### Modifications

The first, second, and third embodiments can be modified as follows. The first, second, and third embodiments and the following modification examples can be combined with each other as long as they are not technically contradictory.
The mode of connection of the communication devices in the communication network system 100 is not limited to the first, second, and third embodiments. That is, the topology of the communication device in the communication network system 100 is not limited to the first, second, and third embodiments. The number of communication buses and the number of connected communication devices in the communication network system 100 are not limited to the first, second, and third embodiments.
In the first, second, and third embodiments, the first element of the freshness value is an upper digit of the freshness value. The first element may not be the most significant digit of the freshness value. In the first, second, and third embodiments, the second element of the freshness value is a lower digit of the freshness value. The second element may not be the least significant digit of the freshness value.
In the first, second, and third embodiments, the communication devices in the communication network system 100 are connected via a communication bus 30. Meanwhile, the communication device in the communication network system 100 may be wirelessly connected.
In the first, second, and third embodiments, as illustrated in FIG. 2, the management device 40 transmits information indicating the values of both the trip counter and the reset counter to another communication device when the first element is counted up. On the other hand, the management device 40 may transmit information indicating only the counting up of the trip counter and the reset counter.
In the first, second, and third embodiments, the transmission device 10 in which the first element has disappeared transmits a message including the freshness value of the minimum value. On the other hand, the freshness value included in the message transmitted by the transmission device 10 after the first element disappears need not be the minimum value. For example, the transmission device 10 may transmit a freshness value in which the first element is the minimum value and the value stored in the second element when the first element is lost or the second element is not lost.
In the first, second, and third embodiments, when the first element stored in the transmission device 10 disappears, the communication device that stores the occurrence of the disappearance stores information indicating that the disappearance has occurred and the time at which the disappearance has occurred. On the other hand, the communication device that stores the occurrence of the disappearance may not store the time at which the disappearance occurred.
In the first embodiment, when transmitting a message, the transmission device 10 stores information indicating that a loss has occurred and a time at which the loss has occurred. On the other hand, the transmission device 10 may store the information indicating the occurrence of the disappearance and the time at which the disappearance has occurred at any time after the stored first element disappears and before receiving the information indicating the first element. For example, the transmission device 10 may store information indicating that the loss has occurred immediately after the loss of the first element has occurred, and a time at which the loss has occurred.
In the second and third embodiments, the transmission device 10 transmits a loss notification after transmitting the message. On the other hand, the transmission device 10 may transmit the loss notification at any time after the stored first element disappears and before receiving the information indicating the first element. For example, the transmission device 10 may transmit the loss notification immediately after the loss of the first element occurs.
In the second and third embodiments, the transmission device 10 transmits the loss notification, thereby simultaneously transmitting the first element stored in the transmission device 10 and the time at which the loss has occurred. On the other hand, the transmission device 10 may transmit the first element stored in the transmission device 10 and the time at which the erasure has occurred by separate notifications.
In the second and third embodiments, the transmission device 10 may not transmit the time at which the loss occurred.
In the second and third embodiments, the time indicated by the loss notification is compared to determine whether the loss notification is due to a retransmission attack. On the other hand, such a determination may not be performed.
In the third embodiment, the management device 40 may serve as the detection device 50.
In the third embodiment, the detection device 50 may not receive information indicating that the authentication of the message has failed from the reception device 20.

What is claimed is:

1. A communication device in a communication network system constituted by
a plurality of communication devices,
a message that includes a freshness value composed of a first element and a second element being transmitted and received between the communication devices,
a communication device that manages the first element, among the communication devices, transmitting information that indicates the first element to another communication device,
a communication device that has received the information that indicates the first element storing the first element indicated by the information,
a transmission-side communication device that transmits the message transmitting the message that includes the freshness value that incorporates the first element stored in the transmission-side communication device itself, and
a reception-side communication device that receives the message attempting authentication of the received message by comparing the freshness value included in the received message and the freshness value that incorporates the first element stored in the reception-side communication device itself and, as a result of attempting the authentication, storing information indicating that the authentication has failed when the authentication has failed, wherein:
the transmission-side communication device includes a processing device; and
the processing device stores information indicating that the first element has been lost after losing the stored first element and before receiving information that indicates the first element.

2. A communication device in a communication network system constituted by a plurality of communication devices,
a message that includes a freshness value composed of a first element and a second element being transmitted and received between the communication devices,
a communication device that manages the first element, among the communication devices, transmitting information that indicates the first element to another communication device,
a communication device that has received the information that indicates the first element storing the first element indicated by the information,
a transmission-side communication device that transmits the message transmitting the message that includes the freshness value that incorporates the first element stored in the transmission-side communication device itself, and
a reception-side communication device that receives the message attempting authentication of the received message by comparing the freshness value included in the received message and the freshness value that incorporates the first element stored in the reception-side communication device itself and, as a result of attempting the authentication, storing information indicating that the authentication has failed when the authentication has failed, wherein:
the reception-side communication device includes a processing device; and
the processing device stores information indicating that the first element has been lost in the transmission-side communication device when receiving a notification from the transmission-side communication device, the notification indicating that the first element stored in the transmission-side communication device has been lost.

3. A communication device in a communication network system constituted by
a plurality of communication devices, a message that includes a freshness value composed of a first element and a second element being transmitted and received between the communication devices,
a communication device that manages the first element, among the communication devices, transmitting information that indicates the first element to another communication device,
a communication device that has received the information that indicates the first element storing the first element indicated by the information,
a transmission-side communication device that transmits the message transmitting the message that includes the freshness value that incorporates the first element stored in the transmission-side communication device itself, and
a reception-side communication device that receives the message attempting authentication of the received message by comparing the freshness value included in the received message and the freshness value that incorporates the first element stored in the reception-side communication device itself and, as a result of attempting the authentication, storing information indicating that the authentication has failed when the authentication has failed, wherein:
a communication device that is neither the transmission-side communication device nor the reception-side communication device, among the communication devices, includes a processing device; and
the processing device stores information indicating that the first element has been lost in the transmission-side communication device when receiving a notification from the transmission-side communication device, the notification indicating that the first element stored in the transmission-side communication device has been lost.

4. The communication device according to claim 1, wherein the processing device stores a time at which the first element has been lost, in addition to the information indicating that the first element has been lost.

5. The communication device according to claim 2, wherein the processing device stores a time at which the first element has been lost, in addition to the information indicating that the first element has been lost.

6. The communication device according to claim 3, wherein the processing device stores a time at which the first element has been lost, in addition to the information indicating that the first element has been lost.

7. The communication device according to claim 2, wherein the processing device stores the information indicating that the first element has been lost and a time at which the first element has been lost when receiving, from the transmission-side communication device, a notification indicating that the first element has been lost and indicating the time at which the first element has been lost, as the notification indicating that the first element stored in the transmission-side communication device has been lost, and the time indicated by the received notification indicates a time that is later than a time indicated by a notification received earlier than the notification.

8. The communication device according to claim 3, wherein the processing device stores the information indicating that the first element has been lost and a time at which the first element has been lost when receiving, from the transmission-side communication device, a notification indicating that the first element has been lost and indicating the time at which the first element has been lost, as the notification indicating that the first element stored in the transmission-side communication device has been lost, and the time indicated by the received notification indicates a time that is later than a time indicated by a notification received earlier than the notification.
